(19) United States
(12) Patent Application Publication
(10) Pub. No.: US 2017/0132881 A1
(43) Pub. Date: May 11, 2017

(54) GAMING MACHINE

(71) Applicants: Jesus FRANCO MUNOZ, Madrid (ES); RECREATIVOS FRANCO, S.A., Madrid (ES)

(72) Inventor: Jesus FRANCO MUNOZ, Madrid (ES)

(21) Appl. No.: 15/321,936

(22) PCT Filed: Jun. 26, 2014
(86) PCT No.: PCT/ES2014/070525

§ 371 Date: Dec. 23, 2016

(51) Int. Cl. G07F 17/32; G07F 17/34

(52) U.S. Cl. CPC G07F 17/3288; G07F 17/3246; G07F 17/326; G07F 17/3272; G07F 17/34

(57) ABSTRACT

The object of the invention is to provide a machine which, while completely autonomous, allows performing drawings in which the actual player can make certain that the drawing exclusively follows the laws of chance and that the result therefore is not pre-programmed according to a pre-established prize cycle. To that end, the machine is based on a physical drawing by means of at least one drum (2) containing balls (5), the machine having reading or identification means (8) for reading or identifying the resulting balls (5), such that, through a game interface and prior to the drawing, the player or players can place their bets. According to another one of the features of the machine, it has been envisaged that there can be multiple game interfaces, a main machine in which the drawing takes place, and a series of satellite machines (12) in which each player places their bets, being defined.

### OBJECT OF THE INVENTION

The present invention relates to a gaming machine of the type of in gaming rooms and the like.

The object of the invention is to provide a machine provided with a drawing drum, whereby it is assured that the prizes to be obtained are merely the result of chance, i.e., in which the prizes do not follow a pre-programmed cycle.

### BACKGROUND OF THE INVENTION

In the scope of practical application of the invention, i.e., the scope of gaming machines used in gaming rooms and the like, machines of this type generally have game mechanisms controlled by a microprocessor, such that this microprocessor is pre-programmed to offer a series of cyclical prizes, depending on the amount of money coming into the machine.

While there are machines of this type with game mechanisms that can act exclusively in accordance with “chance”, and any of the machines described above can also be pre-programmed so that the prizes obtained are based purely on chance, the reality today is that users themselves do not trust machines of this type because it is not possible to know beforehand if the machine actually works one way or the other, given that the game mechanisms thereof are controlled at all times by the mentioned microcontroller.

In parallel, while gaming machines are known to incorporate a rotating drum in their shell, in which drum there are arranged a series of balls or dice provided with identification means allowing identification by the machine once the ball or die in question is extracted, and being able to act depending on the result obtained, mechanisms of this type belong to accessory or secondary games to which access is gained through the “main” game of the machine, which is likewise controlled by a microcontroller “controlling” the prizes according to pre-programmed parameters or guidelines.

Accordingly, there is no known gaming machine in which the drawings of the main game thereof offer the user the guarantee that said drawings are performed based exclusively on chance.

### DESCRIPTION OF THE INVENTION

The gaming machine proposed by the invention solves the drawbacks explained above in a fully satisfactory manner as a result of a novel structuring.

To that end, the proposed machine is based on a main shell in which there is integrated at least one drum in which there are arranged a plurality of balls on which numbers, colors and even animals or any other type of representative figures can be depicted interchangeably, with the particularity that there are associated with said balls identification means allowing identification of said balls by a reader facing a basket of the drum when the corresponding ball is extracted, such that the driving or turning means of the drum, as well as the opening and closing and the access of the ball that is drawn to the corresponding basket, are controlled by a microcontroller, this physical element, i.e., the drum or drums, constituting the main game of the machine.

The main microprocessor of the machine therefore identifies the values obtained in the drum or drums and controls the game states of the machine through corresponding programming software.

More specifically, it has been envisaged that there is arranged on the shell of the machine, or on a series of shells should the machine be a multi-player machine or machines associated with the main machine, a game interface consisting of a screen on which bets are placed prior to the drawing of the drum or drums.

The type of game or bets can be done in many different ways according to different types of programming software, but by means of the described structuring, it is assured that the result obtained in the game does not follow any pre-programmed cycle, but rather is based exclusively on chance, which makes it very appealing for players.

In the event that the machine is a multi-player machine, the main machine will obviously incorporate either wired or wireless communication means for communicating with the satellite machines, with the corresponding control electronics thereof in order to report the result obtained to said machines, these satellite machines having corresponding money insertion means and means for paying out the corresponding prizes, which will be done depending on the result obtained in the main machine.

### DESCRIPTION OF THE DRAWINGS

To complement the description made below and for the purpose of helping to better understand the features of the invention according to a preferred practical embodiment thereof, a set of drawings is attached as an integral part of said description in which the following is depicted with an illustrative and non-limiting character:

FIG. 1 shows a front elevational view of the simplest version envisaged for the gaming machine object of the present invention.

FIG. 2 shows an embodiment variant in which the machine is a multi-position machine.

FIG. 3 shows a graphic depiction of one of the many possibilities for the game interface of the machine on which the corresponding bets can be placed prior to the drawing performed by the machine.

### PREFERRED EMBODIMENT OF THE INVENTION

As can be seen in the described drawings, the machine of the invention consists of a shell (1), which may obviously have any configuration in accordance with any design line envisaged for it, with the particularity that there is arranged on the front face thereof at least one drum (2) associated with a corresponding turning mechanism arranged in correspondence with its side ends (3), which drum (2) can be a cage, as shown in the drawings, or it can be, interchangeably, an essentially spherical transparent body made of plastic or the like.

Each drum (2) has on its surface, in correspondence with the bisector line of the imaginary axis of rotation, a large hole (4) having dimensions that are slightly larger than the dimension of each ball (5) intended to be played in said drum (2).

The mentioned hole (4) is associated with an opening and closing mechanism (6) for opening and closing same, through which one of the balls (5) gains access, once they have been turned a predetermined number of turns, to a cage-like basket (7), having a configuration suitable for receiving therein one of the balls (5), which can have on its surface a number, a color, a representative figure such as an animal, etc. The turning mechanisms of the different drums (2), and the opening and closing mechanism (6) of the hole (4) thereof are electrically associated with an internal microprocessor or microcontroller, to which a series of reading means (8) for reading the balls (5) are likewise associated, for which purpose the balls (5) themselves can incorporate other identification means allowing identification by the system, in addition to their visual identifier arranged on their surface.

Accordingly, the reading means can be of many different types, such as a video camera associated with image identification software, RFID readers, or a bar code or BIDI code reader, for example, for which purpose, in said case, it has been envisaged that there are arranged on the surface of the balls (5) BIDI identification codes identifying the result obtained, in addition to the conventional stenciling corresponding to said result obtained.

The main microprocessor of the machine thereby identifies the values obtained in the drum or drums (2) and provides the result obtained completely by chance through the corresponding software, after which the machine will or will not proceed to give out prizes depending on the type of bets placed by the participating player or players.

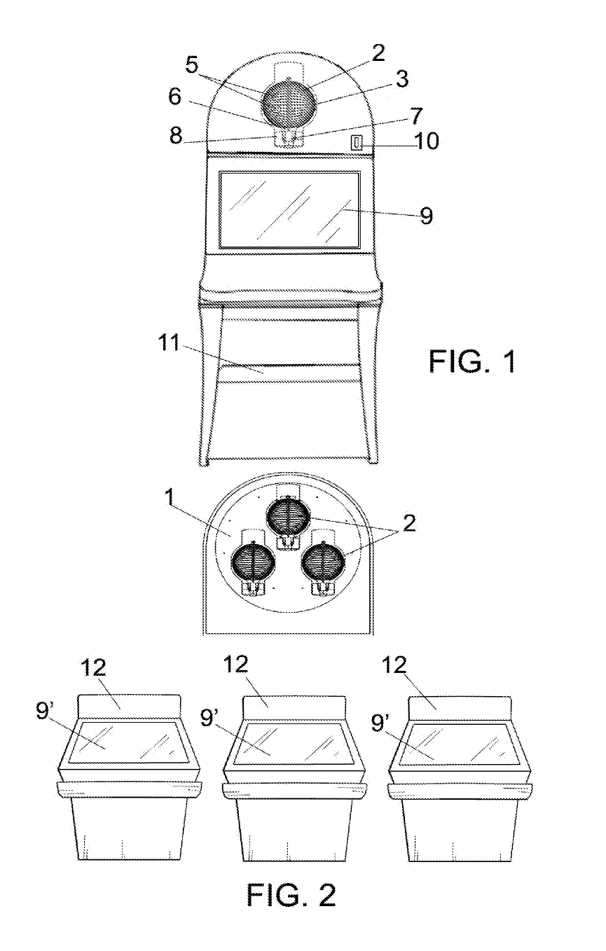

To that end, as shown in the case of FIG. 1, it has been envisaged that the machine incorporates an interface, which is a screen (9), on which a series of either single or multiple bets can be made prior to the drawing performed by the drum, having to that end money insertion means (10) and prize collection means (11).

As can be seen in FIG. 2, the machine can be a multi-player machine, such that instead of arranging the game interface on the shell (1) itself of the machine, it is arranged in respective satellite machines (12) provided with communication means for communicating with the microprocessor or server of the main machine, these satellite machines (12) having corresponding money insertion means and prize collection means, incorporating a touch screen (9′) on which bets are placed prior to the drawing in the main machine.

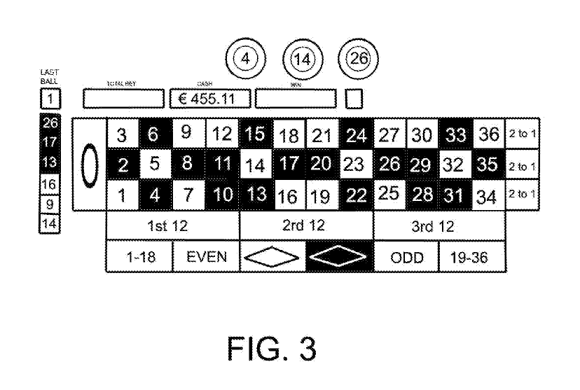

Obviously there are many types of games that can be played and bets placed based on a game in which there are one or more participating drums (2), such that, merely by way of example, FIG. 3 depicts one of the possible multiple game interfaces, in which the drum can be used similarly to a roulette game, where can be multiple types of bets can be placed, whether it is the specific number of the drawn ball, the color, even/odd, etc.

The machine of the invention therefore allows applying the game of roulette to an autonomous machine, replacing the cylinder device with a random drum drawing mechanism, which does not depend on third parties, such as croupiers, for player interaction with the machine, or the participation of other players, all this with certified randomness, such that there are no external factors that help manipulate the drawing.

The invention thereby allows obtaining a machine that is very appealing for players because it allows many various types of bets, all based on a physical drawing with a result that is not controlled electronically, but rather exclusively follows mere chance, unlike what occurs in most gaming machines of this type.

1. A gaming machine, consisting of a shell, in which there is arranged a microprocessor, associated with a game interface, such as a screen, with corresponding money insertion means and prize collection means, with the particularity that the main game of the machine is a drawing on which a bet is previously placed in said interface, in which there is at least one participating drum associated with a corresponding turning mechanism arranged in correspondence with its side ends, said drum having a basket associated with an opening and closing mechanism for gaining access to one of the balls contained in the drum, in said basket, which balls can have a number, a color, or a representative figure on their surface, it having been envisaged that the turning mechanisms of the drum or drums, and the opening and closing mechanism of the basket are electrically associated with the internal microprocessor or microcontroller, to which a series of reading means for reading the balls are likewise associated and through which, with the collaboration of corresponding programming software, the machine is capable of interpreting the result obtained and paying out prizes depending on the bets placed in the interface or screen of the machine.

2. A gaming machine according to claim 1, wherein the game interface is susceptible to being independent of the machine per se, such that a main machine responsible for the drawing and a series of satellite machines provided with communication means for communicating with the main machine, as well as the corresponding game interface and the complementary money insertion means and prize collection means, can be defined.
